(19) United States
(12) Patent Application Publication
(10) Pub. No.: US 2025/0208347 A1
(43) Pub. Date: Jun. 26, 2025

(54) OPTICAL DEVICES AND METHODS OF MANUFACTURE

(71) Applicant: Taiwan Semiconductor Manufacturing Co., Ltd., Hsinchu (TW)

(72) Inventors: Chen-Hua Yu, Hsinchu (TW); Tung-Liang Shao, Hsinchu (TW); Yu-Sheng Huang, Hemei Township (TW)

(21) Appl. No.: 18/666,517

(22) Filed: May 16, 2024

Related U.S. Application Data
(60) Provisional application No. 63/613,231, filed on Dec. 21, 2023.

(51) Int. Cl. G02B 6/13; G02B 6/12

(52) U.S. Cl. CPC G02B 6/13; G02B 6/12004

(57) ABSTRACT

Optical devices and methods of manufacture are presented in which interposers are incorporated with optical devices. In some embodiments a method includes embedding first optical packages within the interposers in order to provide optical bridging between different semiconductor devices. The first optical packages may be embedded with a glass core or metallization layers.

### PRIORITY CLAIM AND CROSS-REFERENCE

This application claims the benefit of U.S. Provisional Application No. 63/613,231, filed on Dec. 21, 2023, entitled “Integration of Optical Engine and Glass Substrate,” which application is hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIG. 10 illustrate a second substrate, in accordance with some embodiments.

FIG. 11 illustrates formation of metallization layers on the second substrate, in accordance with some embodiments.

FIG. 12 illustrates formation of openings within the metallization layers, in accordance with some embodiments.

FIG. 13 illustrates placement of the first optical package within the openings, in accordance with some embodiments.

FIG. 14 illustrates formation of a metallization layer over the first optical package, in accordance with some embodiments.

FIG. 15 illustrates attachment of semiconductor devices, in accordance with some embodiments.

FIGS. 16A-16C illustrate operation of the devices, in accordance with some embodiments.

FIG. 17 illustrates the second substrate, in accordance with some embodiments.

FIG. 18 illustrates forming openings within the second substrate, in accordance with some embodiments.

FIG. 19 illustrates placement of the first optical package within the openings in the second substrate, in accordance with some embodiments.

FIG. 20 illustrates formation of metallization layers adjacent to the second substrate, in accordance with some embodiments.

FIG. 21 illustrates attachment of the semiconductor devices, in accordance with some embodiments.

FIG. 22 illustrates bonding of the interposer substrate to another substrate, in accordance with some embodiments.

FIGS. 23-24C illustrate an embodiment in which the interposer substrate comprises optical components, in accordance with some embodiments.

FIGS. 25A-25C illustrate embodiments which use bridge dies, in accordance with some embodiments.

FIG. 26 illustrates an embodiment in which optical components are formed within a substrate, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which an optical engine is incorporated into a glass substrate in order to help electrically and optically interconnect interposer devices. However, the embodiments presented herein are intended to be illustrative and are not intended to limit the embodiments to the precise descriptions as discussed. Rather, the embodiments discussed may be incorporated into a wide variety of implementations, such as silicon photonics in general, or 3-D ICs with photonic applications, and all such implementations are fully intended to be included within the scope of the embodiments.

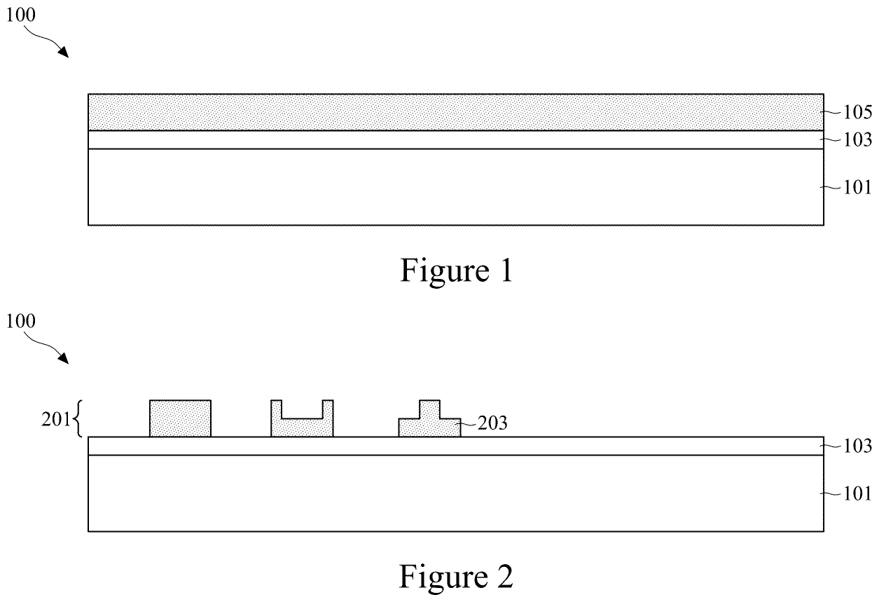

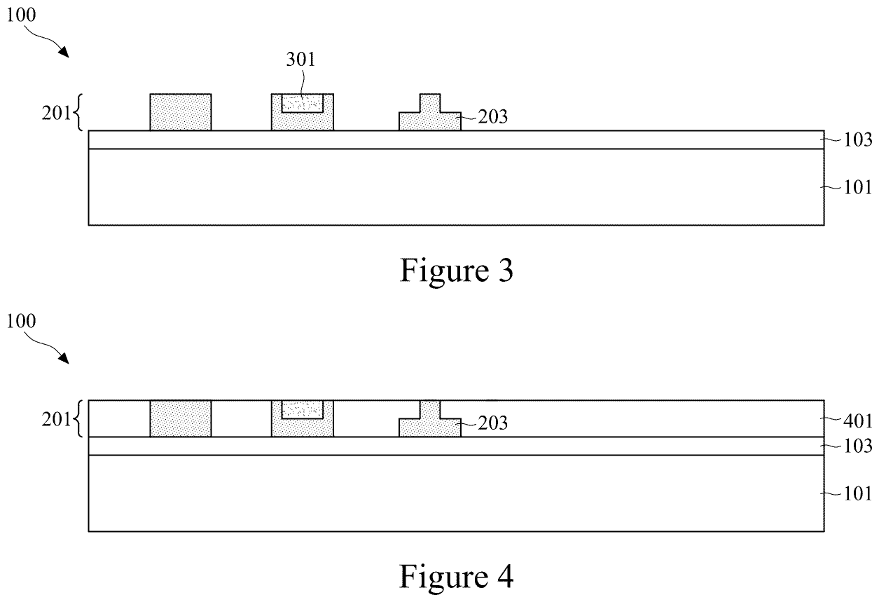

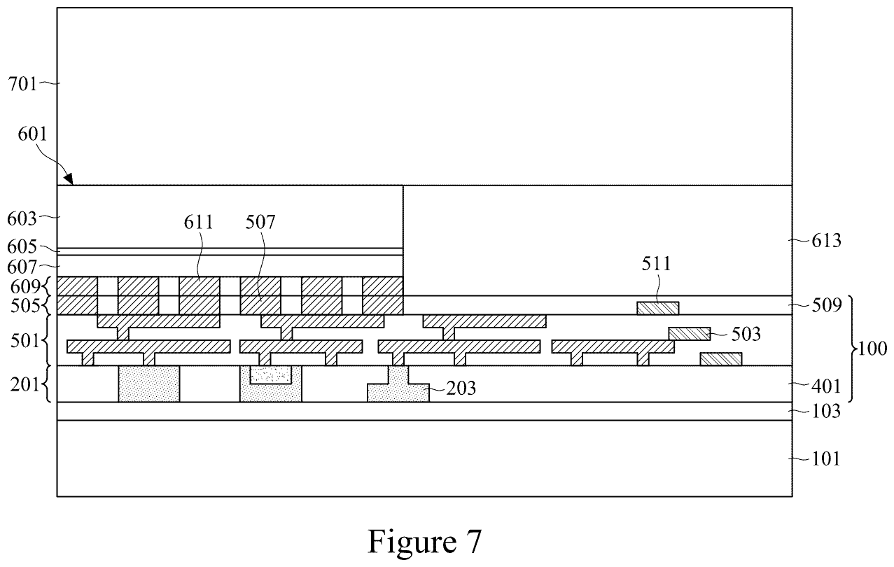

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203 components.

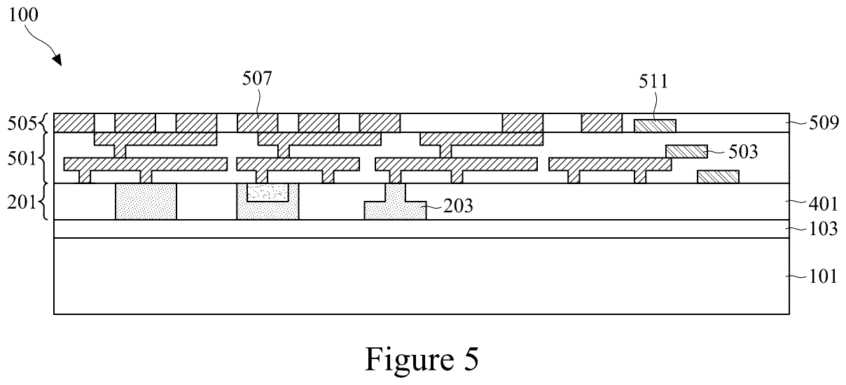

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

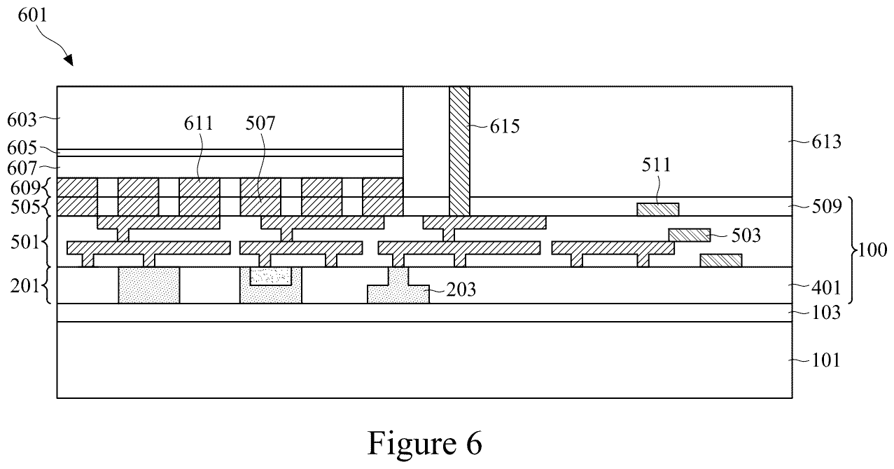

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

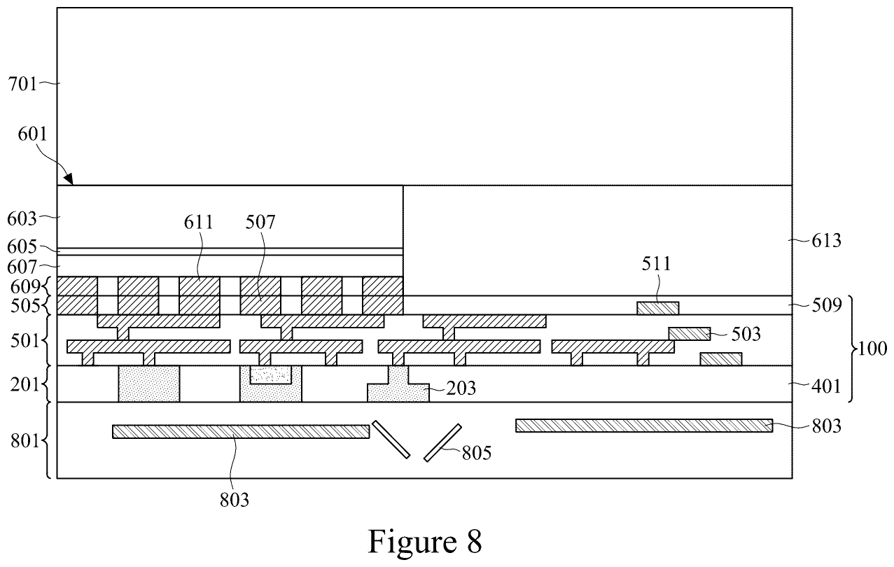

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, and can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first pads 507 within the first bonding layer 505. Once the first openings have been formed within the first dielectric material 509, the first openings may be filled with a seed layer and a plate metal to form the first pads 507 within the first dielectric material 509. The seed layer may be blanket deposited over top surfaces of the first dielectric material 509 and the exposed conductive portions of the underlying layers and sidewalls of the first openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first pads 507 within the first bonding layer 505. In some embodiments a bond pad via (not separately illustrated) may also be utilized to connect the first pads 507 with underlying conductive portions and, through the underlying conductive portions, connect the first pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated second bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the second bond pads 611 may be similar to the first pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 60g.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first pads 507 and the second bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a gap-fill material 613 is deposited in order to fill the space around the first semiconductor device 601 and provide additional support. In an embodiment the gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the second gap-fill material 613 has been deposited, the gap-fill material 613 may be planarized in order to expose the first semiconductor device 6o1. In an embodiment the planarization process may be a chemical mechanical planarization process, a grinding process, or the like. However, any suitable planarization process may be utilized.

Once the second gap-fill material 613 has been formed, connective vias 615 may be formed through either the gap-fill material 613 or the semiconductor substrate 603. In an embodiment the connective vias 615 may be formed by initially forming openings. The openings may be formed by applying and developing a suitable photoresist (not shown), and removing portions of the gap-fill material 613 and/or the semiconductor substrate 603.

Once the openings have been formed, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the openings, a barrier layer (also not independently illustrated) may be formed and the remainder of the openings may be filled with conductive material. The conductive material may comprise copper, although other suitable materials such as aluminum, alloys, doped polysilicon, combinations thereof, and the like, may be utilized. The conductive material may be formed by electroplating copper onto a seed layer (not shown), filling and overfilling the openings. Once the openings have been filled, excess liner, barrier layer, seed layer, and conductive material outside of the openings may be removed through a planarization process such as chemical mechanical polishing (CMP), although any suitable removal process may be used.

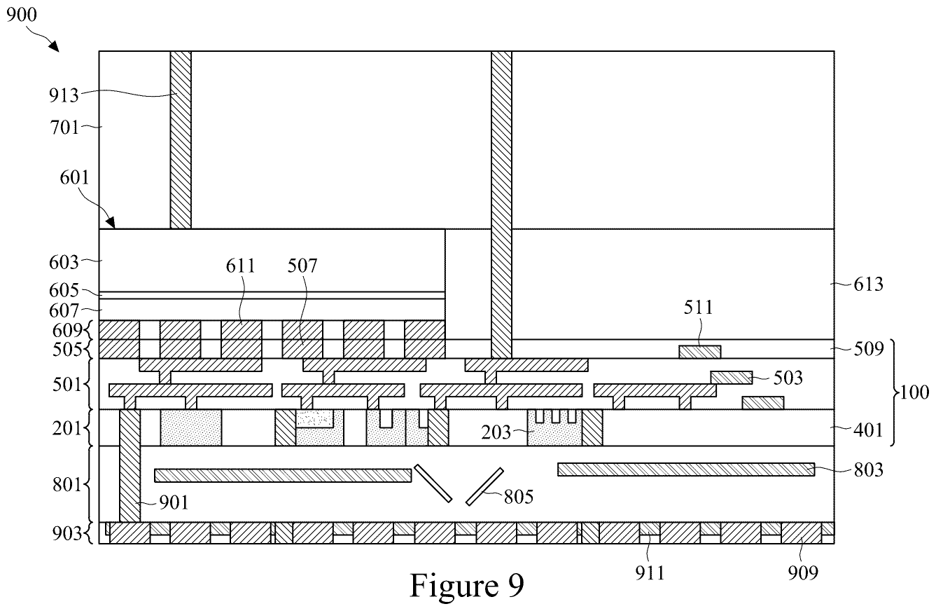

FIG. 7 illustrates an attachment of a support substrate 701 to the first semiconductor device 601 and the gap-fill material 613. In an embodiment the support substrate 701 may be a support material that is transparent to the wavelength of light that is desired to be used, such as silicon, and may be attached using, e.g., an adhesive (not separately illustrated in FIG. 7). However, in other embodiments the support substrate 701 may be bonded to the first semiconductor device 601 and the gap-fill material 613 using, e.g., a bonding process. Any suitable method of attaching the support substrate 701 may be used.

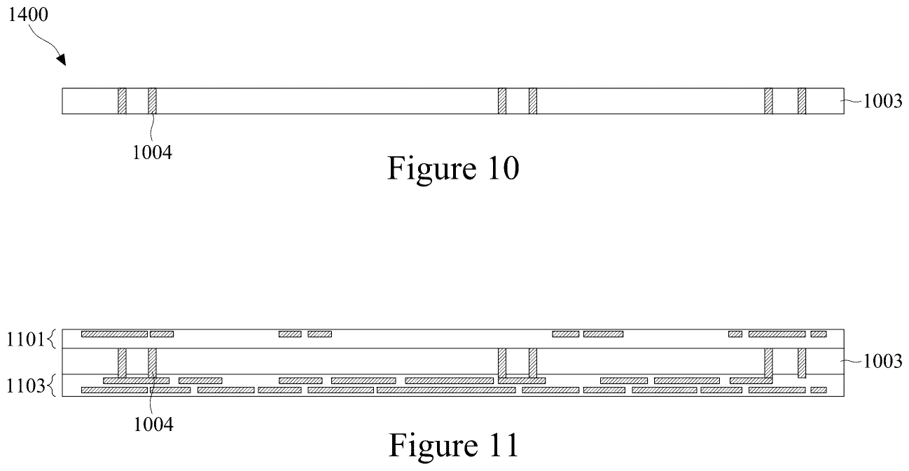

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 8 additionally illustrates that first mirrors 805 may be formed within the second active layer 801. In an embodiment the first mirrors 805 may be formed by initially forming recesses (not separately illustrated in FIG. 8) using, e.g., a photolithographic masking and etching process. Once the recesses have been formed, a mirror coating may be deposited to line the recesses. In an embodiment the mirror coating may be a single layer of a reflective material such as aluminum copper, copper, gold, aluminum, combinations of these, or the like, or else may be a multi-layer structure such as a Bragg's reflector comprising alternating layers of silicon dioxide and amorphous silicon. The individual materials of the mirror coating may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). The material for the mirror coating may be deposited to a thickness of between about 500 Å and about 3000 Å. However, any suitable materials and methods may be utilized in order to form the mirror coating along the sidewalls of the recess.

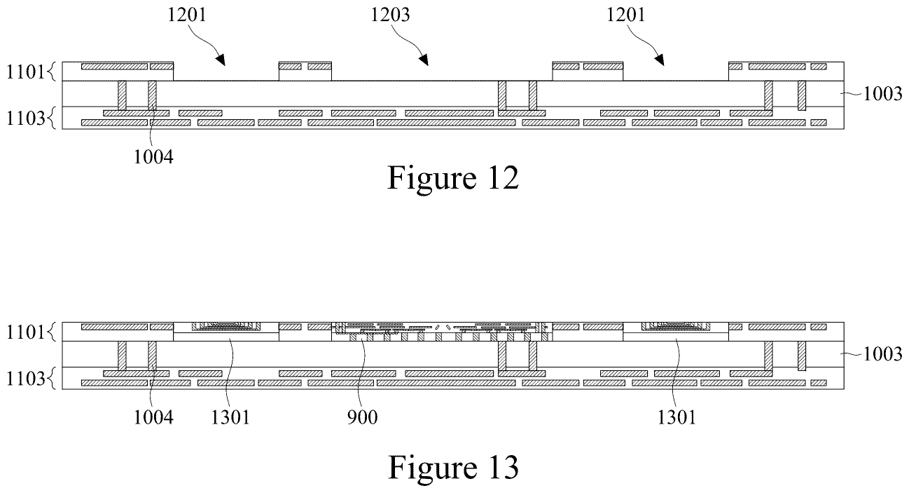

FIG. 9 illustrates formation of first through device vias (TDVs) 901 and formation of a third bonding layer 903. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first pads 507) and even fifth optical components 911 (similar to the third optical components 511). However, any suitable devices may be utilized.

Once the third bonding layer 903 has been formed, connective vias 913 may be formed through the support substrate 701, the gap-fill material 613, and/or the semiconductor substrate 603. In an embodiment the connective vias 913 may be formed using similar processes and materials as the first through device vias 901 described above. However, any suitable processes and materials may be used.

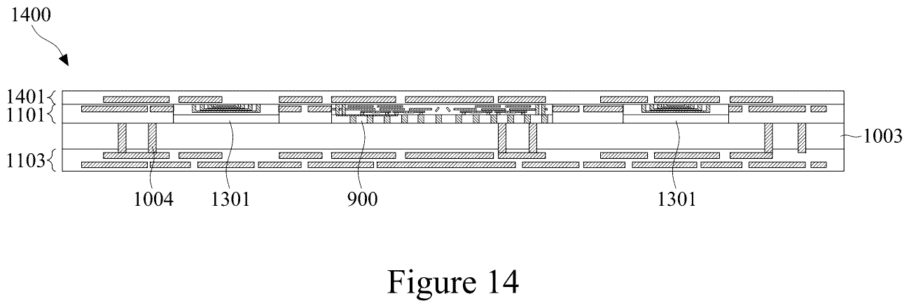

FIG. 10 illustrates an interposer substrate 1400 to which the first optical package 900 (e.g., the structure formed in FIG. 9) will be connected. In an embodiment the interposer substrate 1400 comprises a second substrate 1003 and second through device vias 1004. Looking first at the second substrate 1003, the second substrate 1003 may comprise a material that allows for visual transparency with high dimensional stability under thermal loads, and still has a coefficient of thermal expansion which is close to the silicon found in other parts of the device. In particular embodiments the second substrate 1003 may be different from the first substrate 101 and may be formed of a material that can help prevent warpage, such as a material that has a high rigidity (e.g., a Young's modulus of between about 51 GPa and 320 GPa) and a low coefficient of thermal expansion (e.g., a CTE rang of between about 1 ppm/° C. and about 8 ppm/° C.). In particular embodiments the second substrate 1003 may be glass, aluminum oxide, ceramics, combinations of these, or the like. However, any suitable materials may be utilized.

Using materials such as these enable a larger overall package size that helps realize additional gains from the use of optical interconnects and the speed these interconnects provide. For example, by using these more rigid materials, in some embodiments the second 1003 may extend long distances without warpage than otherwise achievable without warpage. Such longer distances allow the optical interconnect advantages (light travelling faster) to be seen and realized in the package. Additionally, by using a material such as glass, there will be a better integration with the other optical components of the device.

The second through device vias 1004 may be formed to extend through the second substrate 1003 and provide an electrical connection between a first side of the second substrate 1003 to a second side of the second substrate 1003. In an embodiment the second through device vias 1004 may be formed using similar processes and similar materials as the first through device vias 901, such as forming an opening, depositing conductive material within the opening, and then thinning to expose the conductive material, described above with respect to FIG. 9. However, any suitable methods and materials may be utilized.

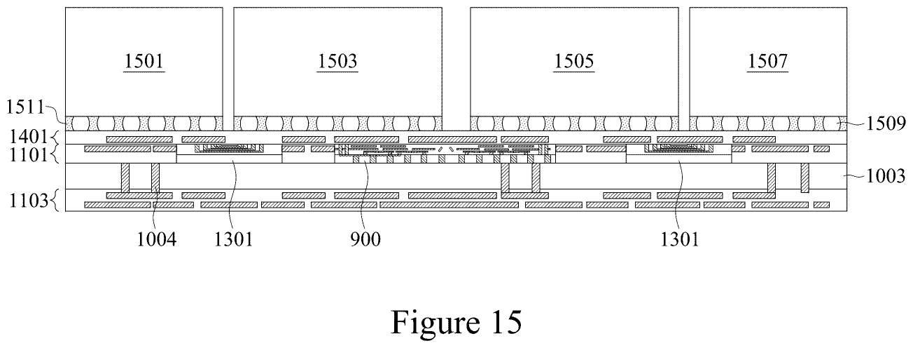

FIG. 11 illustrates formation of a third metallization layer 1101 over a first side of the second substrate 1003. In an embodiment the third metallization layer 1101 may be formed as described above with respect to the first metallization layers 501, such as being alternating layers of dielectric and conductive materials using damascene processes, dual damascene process, or the like. In other embodiments, the third metallization layer 1101 may be formed using a plating process to form and shape conductive material, and then cover the conductive material with a dielectric material. However, any suitable structures and methods of manufacture may be utilized.

In particular embodiments the third metallization layer 1101 may comprise organic dielectric materials. For example, in some embodiments the dielectrics within the third metallization layer 1101 may comprise material such as an epoxy, polyimide, benzocyclobutene (BCB), polybenzoxazole (PBO), combinations of these, or the like. However, in other embodiments the third metallization layer 1101 may comprise inorganic dielectric materials. For example, the dielectrics within the third metallization layer 1101 may comprise materials such as un-doped silicate glass (USG), SiN, SiON, silicon oxide (SiO), combinations thereof, or the like. Any suitable materials and any suitable combination of material may be used for the dielectric materials of the third metallization layer 1101.

FIG. 11 additionally illustrates formation of a fourth metallization layer 1103 on an opposite side of the second substrate 1003 from the third metallization layer 1101. In an embodiment the fourth metallization layer 1103 may be formed as described above with respect to the first metallization layers 501, such as being alternating layers of dielectric and conductive materials using damascene processes, dual damascene process, or the like. In other embodiments, the fourth metallization layer 1103 may be formed using a plating process to form and shape conductive material, and then cover the conductive material with a dielectric material. However, any suitable structures and methods of manufacture may be utilized.

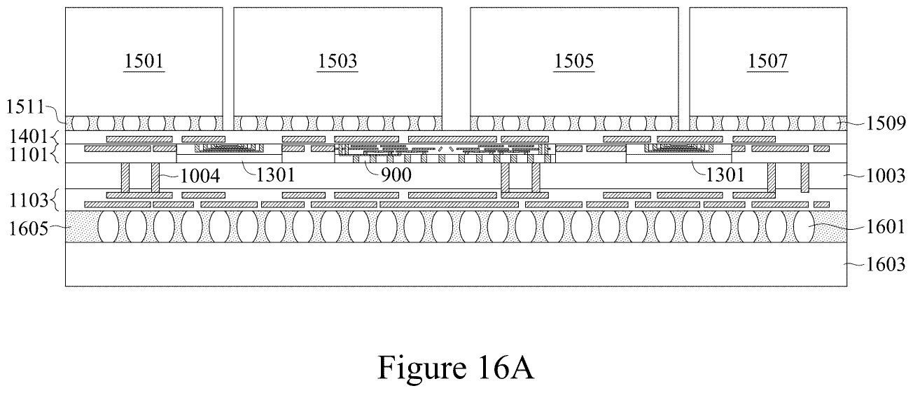

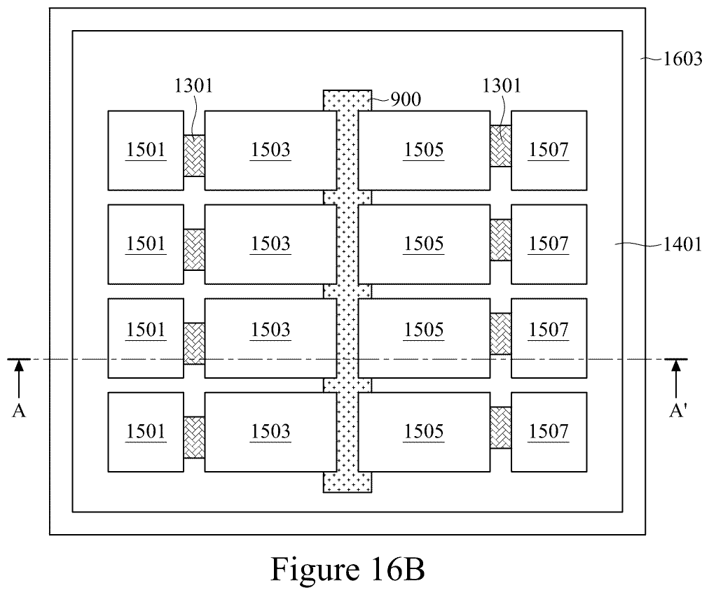

FIG. 12 illustrates a formation of first openings 1201 and second openings 1203 at least partially through the third metallization layers 1101 and exposing the second substrate 1003. Additionally, in some embodiments the second openings 1203 may be formed to expose one or more of the second through device vias 1004. In an embodiment the first openings 1201 are formed to receive first bridge dies 1301 (not illustrated in FIG. 12 but illustrated and discussed further below with respect to FIG. 13) while the second openings 1203 are formed to receive the first optical package 900 (not illustrated in FIG. 12 but illustrated above with respect to FIG. 9). The first openings 1201 and the second openings 1203 may be formed using, e.g., one or more photolithographic masking and etching processes. However, any suitable processes may be utilized.

FIG. 13 illustrates a placement of the first bridge die 1301 into the first openings 1201 and a placement of the first optical package 900 into the second openings 1203 (with the connective vias 913 in electrical connection with the second through device vias 1004. In an embodiment the first bridge die 1301 may be a local silicon interconnect (LSI) die, which is used to bridge and electrically connect subsequently placed devices, and may be placed using, e.g., a pick and place process. Similarly, the first optical package 900 may also be placed using, e.g., a pick and place process. However, any suitable devices and any suitable processes may be utilized.

Once the first bridge die 1301 and the first optical package 900 have been placed, extra space that may be present between the first bridge die 1301, the first optical package 900, and the third metallization layers 1101 may be filled using, e.g., a second gap fill material (not separately illustrated in FIG. 13). In an embodiment the second gap fill material may be formed using similar processes and similar materials as the gap-fill material 613. However, any suitable materials and methods may be utilized.

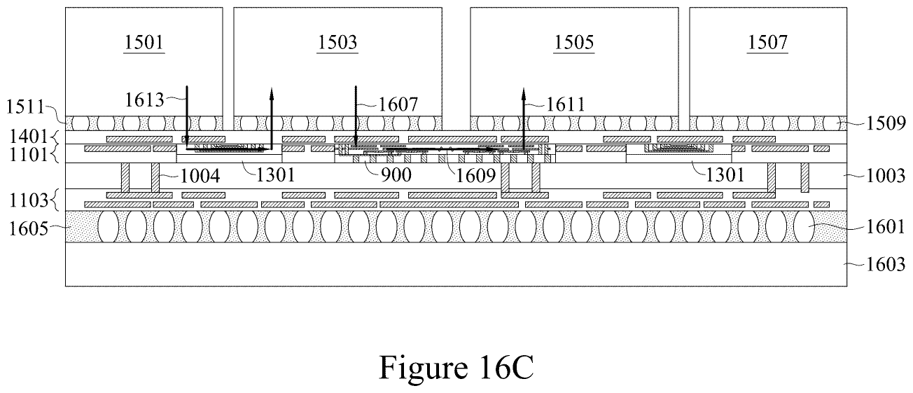

FIG. 14 illustrates a fifth metallization layer 1401 formed over and in electrical connection with the first optical package 900 and the first bridge dies 1301 to form the interposer substrate 1400. In an embodiment the fifth metallization layer 1401 may be formed as described above with respect to the first metallization layers 501, such as being alternating layers of dielectric and conductive materials using damascene processes, dual damascene process, or the like. In other embodiments, the fifth metallization layer 1401 may be formed using a plating process to form and shape conductive material, and then cover the conductive material with a dielectric material. However, any suitable structures and methods of manufacture may be utilized.

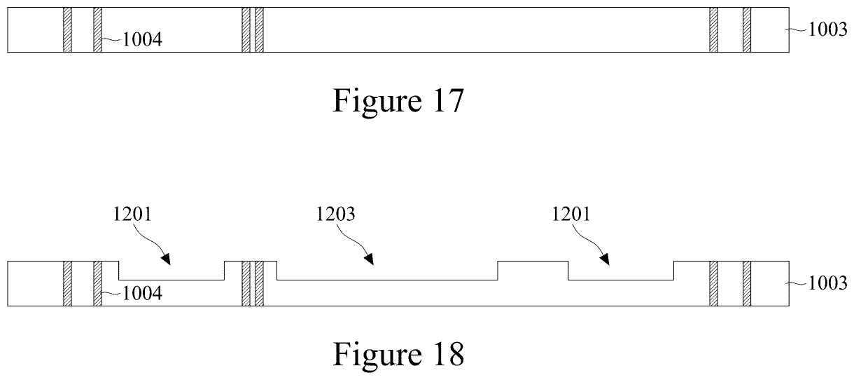

FIG. 15 illustrates placement of a second semiconductor device 1501, a third semiconductor device 1503, a fourth semiconductor device 1505, and a fifth semiconductor device 1507 onto the fifth metallization layer 1401. In an embodiment the second semiconductor device 1501, the third semiconductor device 1503, the fourth semiconductor device 1505, and the fifth semiconductor device 1507 may each be a functional die such as a high bandwidth memory (HBM) module, an xPU, a logic die, a 3DIC die, a CPU, a GPU, a SoC die, a MEMS die, combinations of these, or the like. In a particular embodiment the second semiconductor device 1501 and the fifth semiconductor device 1507 may be HBM dies, while the third semiconductor device 1503 and the fourth semiconductor device 1505 are xPU devices. However, any suitable device with any suitable functionality, may be used, and all such devices are fully intended to be included within the scope of the embodiments.

In an embodiment the second semiconductor device 1501, the third semiconductor device 1503, the fourth semiconductor device 1505, and the fifth semiconductor device 1507 may be bonded to the fifth metallization layer 1401 using, e.g., first external connectors 1509. In an embodiment the first external connectors 1509 may be conductive bumps (e.g., C4 bumps, ball grid arrays, microbumps, etc.) or conductive pillars utilizing materials such as solder and copper. In an embodiment in which the first external connectors 1509 are contact bumps, the first external connectors 1509 may comprise a material such as tin, or other suitable materials, such as silver, lead-free tin, or copper. In an embodiment in which the first external connectors 1509 are tin solder bumps, the first external connectors 1509 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

The first external connectors 1509 may be aligned with corresponding conductive connections on the fifth metallization layer 1401. Once aligned the first external connectors 1509 may then be reflowed in order to bond the second semiconductor device 1501, the third semiconductor device 1503, the fourth semiconductor device 1505, and the fifth semiconductor device 1507 to the interposer substrate 1400. However, any suitable bonding process may be used to connect the second semiconductor device 1501, the third semiconductor device 1503, the fourth semiconductor device 1505, and the fifth semiconductor device 1507 to the fifth metallization layer 1401.

Once bonded, a first underfill 1511 may be placed around the first external connectors 1509. In an embodiment the first underfill 1511 is a protective material used to cushion and support the structure from operational and environmental degradation, such as stresses caused by the generation of heat during operation. The first underfill 1511 may be placed using an injection process with capillary action or may be otherwise formed, and the first underfill 1511 may, for example, comprise a liquid epoxy that is dispensed then cured to harden.

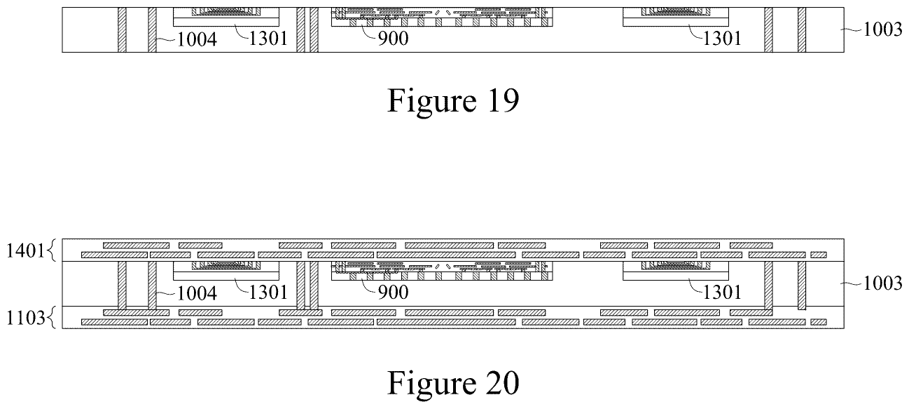

FIG. 16A illustrates a placement of second external connectors 1601 on the fourth metallization layer 1103. In an embodiment the second external connectors 1601 may be formed using similar processes and materials as the first external connectors 1509. However, any suitable materials and processes may be utilized.

FIG. 16A additionally illustrates a bonding of the fourth metallization layer 1103 to a second substrate 1603 using the second external connectors 1601. In an embodiment the second substrate 1603 may be a package substrate, which may be a printed circuit board (PCB) or the like. The second substrate 1603 may include one or more dielectric layers and electrically conductive features, such as conductive lines and vias. In some embodiments, the second substrate 1603 may include through-vias, active devices, passive devices, and the like. The second substrate 1603 may further include conductive pads formed at the upper and lower surfaces of the second substrate 1603.

The second external connectors 1601 may be aligned with corresponding conductive connections on the second substrate 1603. Once aligned the second external connectors 1601 may then be reflowed in order to bond the second substrate 1603 to the fourth metallization layer 1103. However, any suitable bonding process may be used to connect the interposer substrate 1400 to the second substrate 1603. Finally, a second underfill 1605 (similar to the first underfill 1511) may be dispensed and cured.

FIG. 16B illustrates a top down view of the first optical package 900 acting as a bridge between multiple ones of the third semiconductor devices 1503 and the fourth semiconductor devices 1505, with the line labeled A-A′ illustrating the cross-section illustrated in FIG. 16A. FIG. 16B additionally illustrates the use of the first bridge dies 1301 to bridge electrical connections between, e.g., the second semiconductor devices 1501 and the third semiconductor devices 1503 and also to bridge electrical connections between the fourth semiconductor devices 1505 and the fifth semiconductor devices 1507.

FIG. 16C illustrates that, in operation, the first optical package 900 receives first electrical signals (represented in FIG. 16C by the arrow labeled 1607) from, e.g., the third semiconductor device 1503 and through the fifth metallization layer 1401 and converts the first electrical signals 1607 into first optical signals (represented in FIG. 16C by the arrow labeled 1609). The first optical signals 1609 may then be routed and transmitted within the first optical package 900 in order to take advantage of the speed and heat generation (or lack thereof) of optical signals. Once routed, the first optical signals 1609 may then be converted into second electrical signals (represented in FIG. 16C by the arrow labeled 1611) and transmitted through the fifth metallization layer 1401 to the fourth semiconductor device 1505. In other embodiments, the first optical package 900 may further receive, route, and transmit optical signals between the third semiconductor device 1503 and the fourth semiconductor device 1505. Any suitable combination of electrical signals and optical signals may be received and routed, and all suitable combinations are fully intended to be included within the scope of the embodiments.

Looking next at the first bridge dies 1301, the first bridge dies 1301 may receive third electrical signals (represented in FIG. 16C by the arrow labeled 1613) from, e.g., the second semiconductor device 1501 and through the fifth metallization layer 1401. The third electrical signals 1613 are then routed (without conversion to optical signals). Once routed, the third electrical signals 1613 may then be transmitted through the fifth metallization layer 1401 to the third semiconductor device 1503. However, any suitable pathway may be utilized.

By incorporating the first optical package 900 into the interposer substrate 1400, the first optical package 900 can be used to electrically and optically interconnect the overlying devices. As such, shorter distance connections can be made with electrical interconnects while longer distance connections may be made with optical connections. For example, as shown in FIG. 16B, longer signals that travel in the column direction and interconnecting multiple rows of devices (e.g., semiconductor devices 1503 and 1505) can travel via optical signals through the optical engine bridge (e.g., first optical package goo) for increased speed; while shorter signals that travel in the row direction and interconnect only between two devices (e.g., semiconductor devices 1501 and 1503 and/or 1505 and 1507) can travel via electrical signals through electrical bridges (first bridge dies 1301). In some embodiments, the optical engine bridge interconnect between columns of logic devices for processing, which requires higher processing speed, while the electrical bridges interconnect between a logic device and a memory device, which has lower speed requirements. Accordingly, the longer connections can be made with better power, performance, area, and cost (PPAC) for the overall device. As such, the advantages of scalability and electrical/optical can be integrated in the packages.

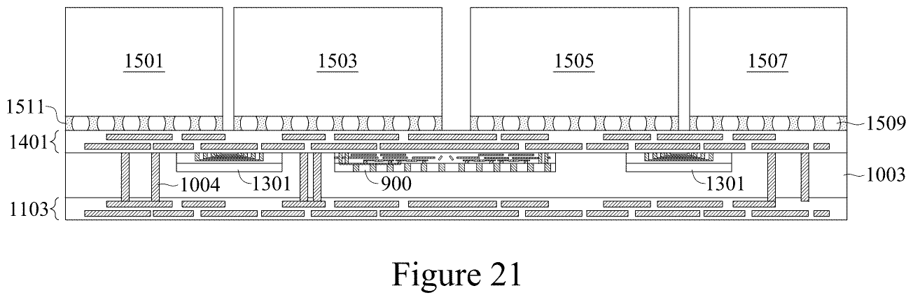

FIGS. 17-22 illustrate another embodiment in which the first optical package 900 and the first bridge dies 1301, instead of being embedded within the third metallization layer 1101 as described above with respect to FIGS. 11-16C, are instead embedded within the second substrate 1003. Looking first at FIG. 17, there is illustrated the second substrate 1003 (e.g., glass) and a forming of the second through device vias 1004 as described above with respect to FIG. 10. However, any suitable materials and devices may be used and formed.

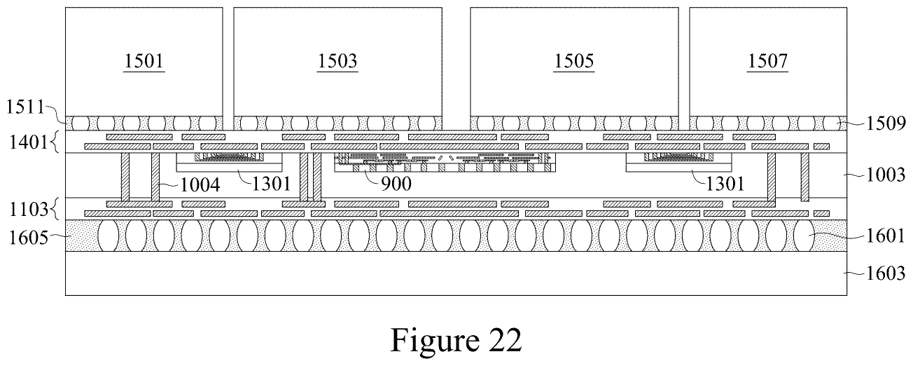

FIG. 18 illustrates formation of the first openings 1201 and the second openings 1203. In this embodiment, however, the first openings 1201 and the second openings 1203 are formed within the second substrate 1003 using, e.g., one or more photolithographic masking and etching processes. However, any suitable methods may be utilized.

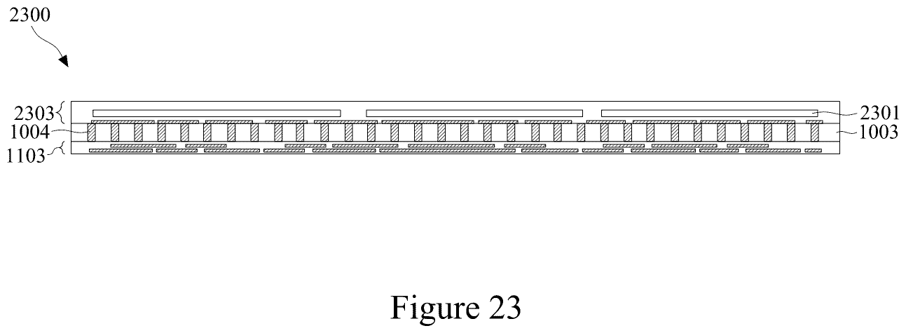

FIG. 19 illustrates a placement of the first optical package 900 and the first bridge dies 1301 within the first openings 1201 and the second openings 1203 within the second substrate 1003. In an embodiment the first optical package 900 and the first bridge dies 1301 may be placed as described above with respect to FIG. 13, such as placing the first optical package 900 and the first bridge dies 1301, and then gap filling the spaces around the first optical package 900 and the first bridge dies 1301. However, any suitable methods and materials may be utilized.

In this embodiment, however, the first optical package may be formed specifically for placement within the second substrate 1003. For example, in embodiments in which the second through device vias 1004 are not formed to make connection with the first optical package 900, the first optical package 900 may be formed without the connective vias 913). However, any suitable combination of electrical and optical connections may be utilized.

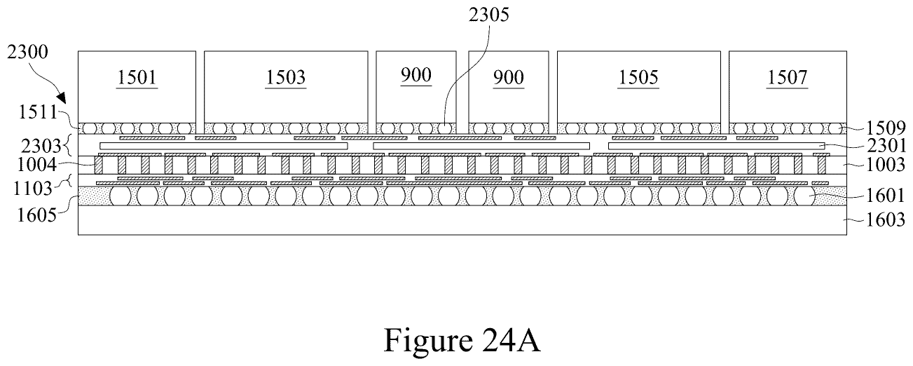

FIG. 20 illustrates that, once the first optical package 900 and the first bridge dies 1301 are placed, the fourth metallization layer 1103 and the fifth metallization layer 1401 may be formed to form electrical connections to the first bridge dies 1301 and the first optical package 900. In an embodiment the fourth metallization layer 1103 and the fifth metallization layer 1401 may be formed as described above with respect to FIG. 11 and FIG. 14, respectively. However, any suitable methods and steps of manufacture may be used.

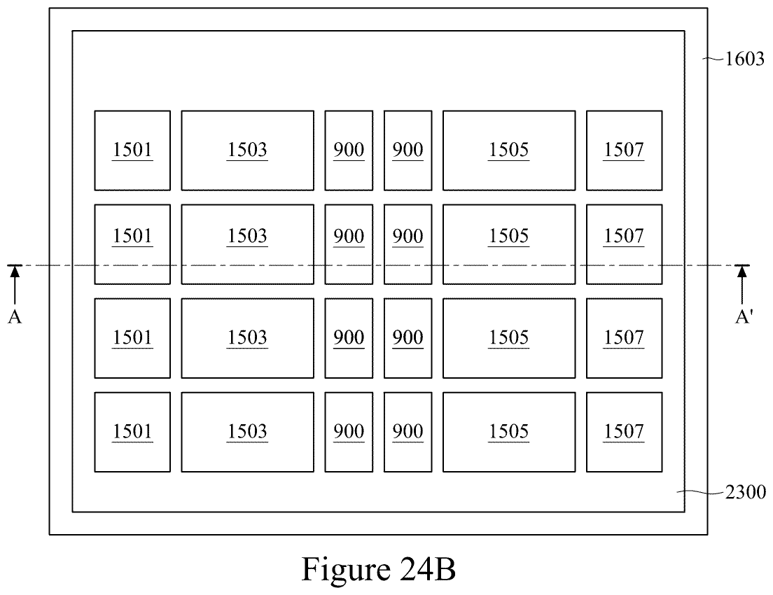

FIG. 21 illustrates a bonding of the second semiconductor device 1501, the third semiconductor device 1503, the fourth semiconductor device 1505, and the fifth semiconductor device 1507 to the fifth metallization layer 1401. In an embodiment the third semiconductor device 1503, the fourth semiconductor device 1505, and the fifth semiconductor device 1507 may be bonded to the fifth metallization layer 1401 as described above with respect to FIG. 15. However, any suitable method may be utilized.

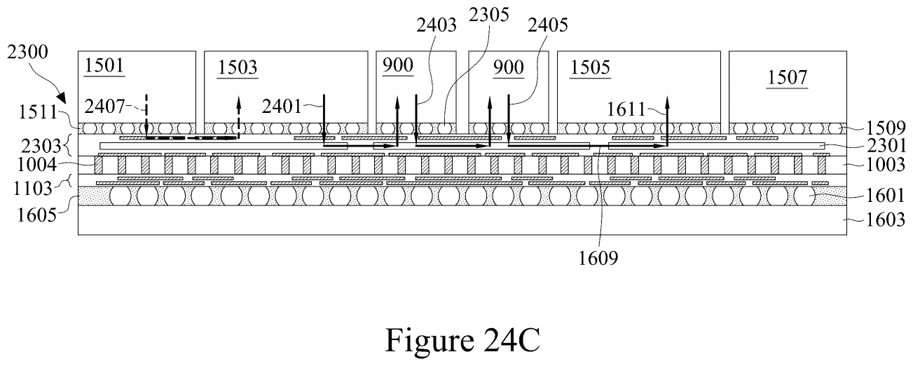

FIG. 22 illustrates a bonding of the fourth metallization layer 1103 to the second substrate 1603. In an embodiment the fourth metallization layer 1103 is bonded to the second substrate 1603 using the second external connectors 1601 as described above with respect to FIG. 16A. However, any suitable methods and materials may be utilized.

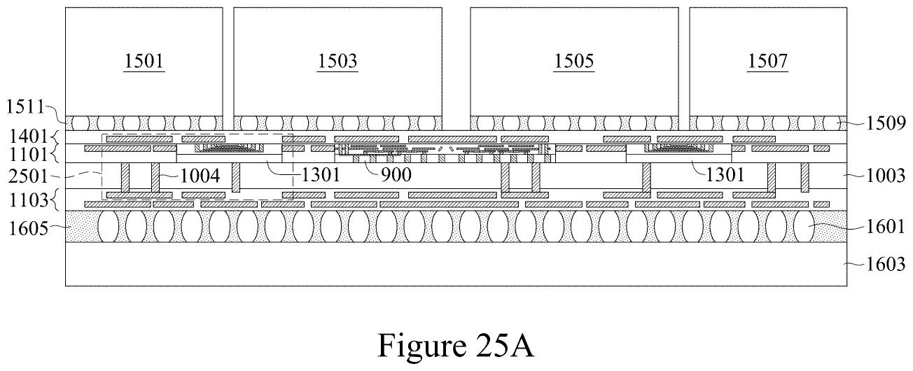

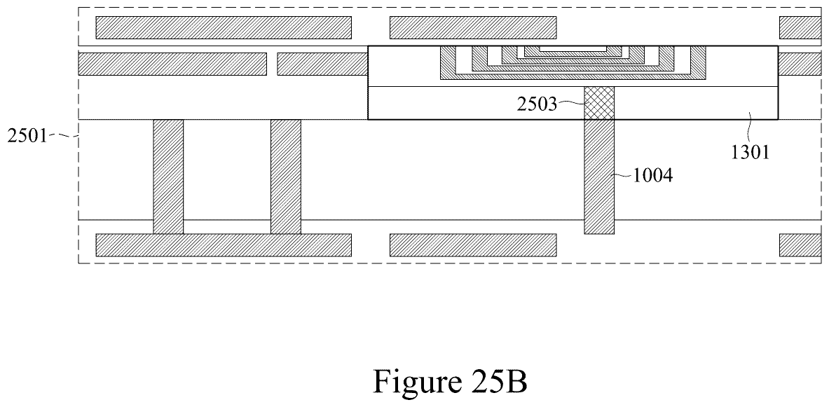

FIGS. 23-24B illustrate yet another embodiment which utilizes a second interposer substrate 2300 with sixth optical components 2301. In this embodiment, and looking first at FIG. 23, the second substrate 1003 and the second through device vias 1004 are formed as described above with respect to FIG. 10. Additionally, once the second through device vias 1004 have been formed, the fourth metallization layer 1103 without optical components are formed along one side of the second substrate 1003.

In this embodiment, however, instead of forming the third metallization layer 1101 along the other side of the second substrate 1003, a sixth metallization layer 2303 is formed with the sixth optical components 2301 in addition to electrically conductive connections. In an embodiment the third metallization layer 1101 with the sixth metallization layer 2303 may be formed using similar methods and materials as the first metallization layers 501 with the second optical components 503. However, any suitable combination of methods and materials may be utilized.

FIG. 24A illustrates that, in this embodiment, one or more of the first optical packages 900 are bonded to the sixth metallization layer 2303 of the second interposer substrate 2300 instead of being embedded within one of the metallization layers of the second interposer substrate 2300. In an embodiment the first optical packages 900 may be bonded to the sixth metallization layer 2303 using, e.g., third external connectors 2305. In an embodiment the third external connectors 2305 may be formed using similar processes and materials as the first external connectors 1509 (e.g., solder balls) and the first optical packages 900 may be bonded as described above with respect to FIG. 15 (e.g., a reflow process). However, any suitable methods may be utilized in order to bond the first optical packages 900 to the sixth metallization layer 2303.

FIG. 24A additionally illustrates a bonding of the second semiconductor device 1501, the third semiconductor device 1503, the fourth semiconductor device 1505, and the fifth semiconductor device 1507 to the sixth metallization layer 2303. In an embodiment the second semiconductor device 1501, the third semiconductor device 1503, the fourth semiconductor device 1505, and the fifth semiconductor device 1507 may be bonded as described above with respect to FIG. 15. However, any suitable method may be utilized.

Finally, FIG. 24A illustrates a bonding of the fourth metallization layer 1103 to the second substrate 1603. In an embodiment the fourth metallization layer 1103 is bonded to the second substrate 1603 using the second external connectors 1601 as described above with respect to FIG. 16A. However, any suitable methods and materials may be utilized.

FIG. 24B illustrates a top down view of the first optical packages 900 acting as bridges between multiples one of the third semiconductor devices 1503 and the fourth semiconductor devices 1505, with the line labeled A-A′ illustrating the cross-section illustrated in FIG. 23A. In this embodiment, however, the sixth optical components 2301 are utilized to help route the optical signals between the various devices.

Looking at FIG. 24C, a fourth electrical signal (represented in FIG. 24C by the arrow labeled 2401) may be generated by the third semiconductor device 1503, routed into the sixth metallization layer 2303 and then transmitted to one of the first optical packages 900. The one of the first optical packages 900 receives the fourth electrical signal 2401 and converts it to a second optical signal (represented in FIG. 24C by the arrow labeled 2403), which is then routed back to the sixth optical components 2301, which routes the second optical signal 2403 to a second one of the first optical packages 900. The second one of the first optical packages 900 receives the second optical signal 2403 and reconverts it back to a fifth electrical signal (represented by the arrow labeled 2405). The fifth electrical signal 2405 may then be routed from the second one of the first optical packages 900 to, e.g., the fourth semiconductor device 1505, or any other suitable device.

Additionally, a sixth electrical signal (represented in FIG. 24C by the arrows labeled 2407) may be generated by the second semiconductor device 1501 and routed into the sixth metallization layer 2303. From the sixth metallization layer 2303, the sixth electrical signal 2407 may be routed through the sixth metallization layer 2303 and then transmitted into the third semiconductor devices 1503. Additionally, while not specifically illustrated in FIG. 24C, the sixth electrical signal 2407 may also be routed not only through the sixth metallization layer 2303, but also through any of the first bridge dies 1301 that may be present (see, e.g., FIG. 16C)

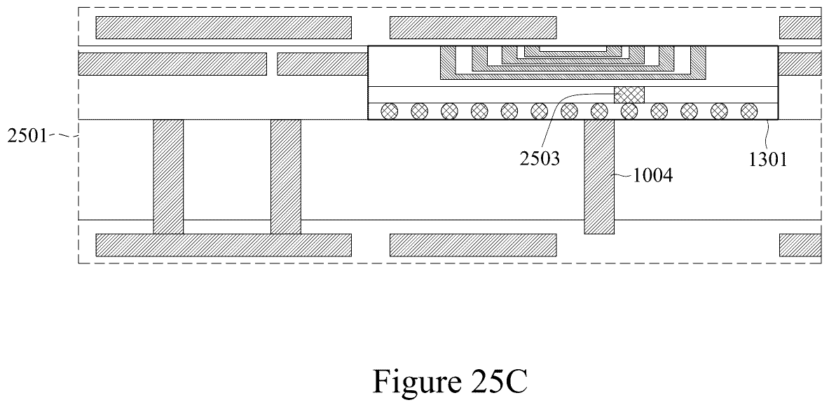

FIGS. 25A-25B illustrate yet another embodiment similar to the embodiment described above with respect to FIGS. 16A, but in which the bridge dies 1301 are connected to the second through device vias 1004 that extend through the second substrate 1003, with FIG. 25B illustrated a zoomed-in view of the dashed box labeled 2501 in FIG. 25A. As can be seen in FIG. 25B, in this embodiment the bride dies 1301 may be formed with one or more third through device vias 1503. In an embodiment the third through device vias 1503 may be formed using similar processes and materials as the second through device vias 1004. However, any suitable processes may be utilized. Once the third through device vias 1004 have been formed, the bridge dies 1301 may be attached to the second substrate 1003. In an embodiment, the bridge dies 1301 are placed in order to connect the third through device vias 1503 to the second through device vias 1004 (in the second substrate 1003). The bridge dies 1301 may be connected using a dielectric-to dielectric and metal-to-metal bonding process. However, any suitable bonding process may be utilized. FIG. 25C illustrates one such alternative bonding process that may be used to connect the bridge dies 1301 to the second through device vias 1004. In this embodiment, instead of using a bonding process such as dielectric-to-dielectric and metal-to-metal bonding process, uses one or more microbumps 2505 in order to make electrical connection to the second through device vias 1004 or the rest of the fifth metallization layer 1401.

By incorporating the first optical package 900 with the interposer substrate 1440, the first optical package 900 can be used to electrically and optically interconnect the overlying devices. As such, shorter distance connections can be made with electrical interconnects while longer distance connections may be made with optical connections. For example, as shown in FIG. 24B, longer signals that travel in the column direction and interconnecting multiple rows of devices (e.g., semiconductor devices 1503 and 1505) can travel via optical signals through the optical engine bridge (e.g., adjacent first optical packages goo) for increased speed; while shorter signals that travel in the row direction and interconnect only between two devices (e.g., semiconductor devices 1501 and 1503 and/or 1505 and 1507) can travel via electrical signals through electrical bridges (first bridge dies 1301). In some embodiments, the optical engine bridge interconnect between columns of logic devices for processing, which requires higher processing speed, while the electrical bridges interconnect between a logic device and a memory device, which has lower speed requirements. Accordingly, the longer connections can be made with better power, performance, area, and cost (PPAC) for the overall device. As such, the advantages of scalability and electrical/optical can be integrated in the packages.

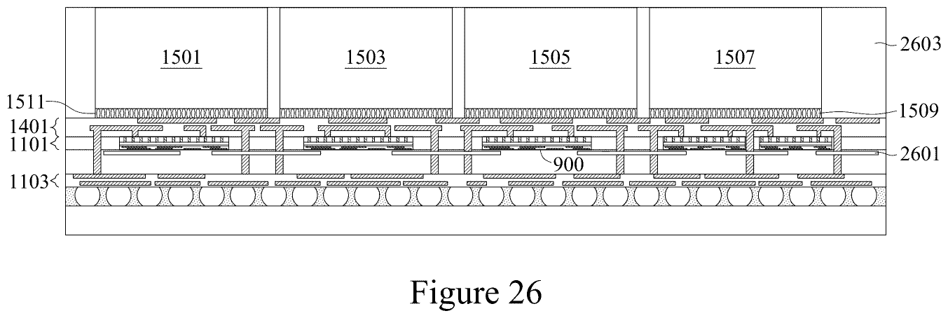

FIG. 26 illustrates yet another embodiment similar to the embodiment illustrated and discussed above with respect to FIG. 16A, but in which seventh optical components 2601 are formed within the second substrate 1003 in order to provide interconnection between the various first optical packages 900. In an embodiment the seventh optical components 1601 may be formed using an implantation method, or else by etching an opening, depositing and patterning core material, and then refilling any remaining openings with additional material of the second substrate 1003. However, any suitable materials and processes may be utilized.

Additionally in this embodiment, an encapsulant 2603 may be placed in order to encapsulate the second semiconductor device 1501, the third semiconductor device 1503, the fourth semiconductor device 1505, and the fifth semiconductor device 1507. In an embodiment the encapsulant 2603 may be a material such as a molding compound placed using an injection molding process. Once in place, the molding compound may be cured and planarized. However, any suitable material and process may be used.

In an embodiment, a method of manufacturing an optical device includes: forming a first metallization layer adjacent to a first substrate; embedding a first optical package within the first metallization layer; and forming a second metallization layer adjacent to the first optical package. In an embodiment the first substrate comprises first through substrate vias. In an embodiment the method further includes forming a third metallization layer on an opposite side of the first substrate from the first metallization layer. In an embodiment at least one of the first though substrate vias is electrically connected to the first optical package. In an embodiment the method further includes attaching a first semiconductor device to the second metallization layer. In an embodiment the method further includes embedding a first bridge device within the first metallization layer. In an embodiment the method further includes: attaching a second semiconductor device to the second metallization layer, wherein the second semiconductor device is electrically connected to the first semiconductor device through the first bridge device; and attaching a third semiconductor device to the second metallization layer, wherein the third semiconductor device is electrically connected to the first semiconductor device through the first optical package.

In another embodiment, a method of manufacturing an optical device includes: forming through substrate vias in a substrate core, the substrate core having a rigidity of between about 51 GPa and about 320 GPa; forming a first metallization layer on the substrate core, the first metallization layer comprising optical components; forming a second metallization layer on an opposite side of the substrate core from the first metallization layer; attaching a first optical package to the first metallization layer; attaching a second optical package to the first metallization layer; and attaching a first semiconductor device to the first metallization layer. In an embodiment the substrate core is a glass substrate. In an embodiment the method includes connecting a second semiconductor device to the first optical package through the first metallization layer. In an embodiment the method further includes connecting a third semiconductor device to the second optical package through the first metallization layer. In an embodiment the third semiconductor device is a high bandwidth memory. In an embodiment the attaching the first optical package is performed at least in part with a reflow process. In an embodiment the method further includes attaching the second metallization layer to a second substrate.

In yet another embodiment an optical device includes: an interposer substrate; and a first optical package embedded within the interposer substrate, wherein a first metallization layer of the interposer substrate is on a first side of the first optical package, a second metallization layer of the interposer substrate is on a second side of the first optical package, and a glass core of the interposer substrate is disposed between the first metallization layer and the second metallization layer. In an embodiment the first optical package is embedded within the glass core. In an embodiment the optical device further includes a first bridge die embedded within the glass core. In an embodiment the first optical package is embedded within a third metallization layer between the first metallization layer and the glass core. In an embodiment the optical device further includes a first bridge die embedded within the third metallization layer. In an embodiment the optical device further includes a first semiconductor device and a second semiconductor device bonded to the first metallization layer, the first semiconductor device connected to the second semiconductor device through the first optical package.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing an optical device, the method comprising:
forming a first metallization layer adjacent to a first substrate;
embedding a first optical package within the first metallization layer; and
forming a second metallization layer adjacent to the first optical package.

2. The method of claim 1, wherein the first substrate comprises first through substrate vias.

3. The method of claim 2, further comprising forming a third metallization layer on an opposite side of the first substrate from the first metallization layer.

4. The method of claim 3, wherein at least one of the first though substrate vias is electrically connected to the first optical package.

5. The method of claim 1, further comprising attaching a first semiconductor device to the second metallization layer.

6. The method of claim 5, further comprising embedding a first bridge device within the first metallization layer.

7. The method of claim 6, further comprising:
attaching a second semiconductor device to the second metallization layer, wherein the second semiconductor device is electrically connected to the first semiconductor device through the first bridge device; and
attaching a third semiconductor device to the second metallization layer, wherein the third semiconductor device is electrically connected to the first semiconductor device through the first optical package.

8. A method of manufacturing an optical device, the method comprising:
forming through substrate vias in a substrate core, the substrate core having a rigidity of between about 51 GPa and about 320 GPa;
forming a first metallization layer on the substrate core, the first metallization layer comprising optical components;
forming a second metallization layer on an opposite side of the substrate core from the first metallization layer; and
attaching a first optical package to the first metallization layer;
attaching a second optical package to the first metallization layer; and
attaching a first semiconductor device to the first metallization layer.

9. The method of claim 8, wherein the substrate core is a glass substrate.

10. The method of claim 9, further comprising connecting a second semiconductor device to the first optical package through the first metallization layer.

11. The method of claim 10, further comprising connecting a third semiconductor device to the second optical package through the first metallization layer.

12. The method of claim 11, wherein the third semiconductor device is a high bandwidth memory.

13. The method of claim 12, wherein the attaching the first optical package is performed at least in part with a reflow process.

14. The method of claim 13, further comprising attaching the second metallization layer to a second substrate.

15. An optical device comprising:
an interposer substrate; and
a first optical package embedded within the interposer substrate, wherein a first metallization layer of the interposer substrate is on a first side of the first optical package, a second metallization layer of the interposer substrate is on a second side of the first optical package, and a glass core of the interposer substrate is disposed between the first metallization layer and the second metallization layer.

16. The optical device of claim 15, wherein the first optical package is embedded within the glass core.

17. The optical device of claim 16, further comprising a first bridge die embedded within the glass core.

18. The optical device of claim 15, wherein the first optical package is embedded within a third metallization layer between the first metallization layer and the glass core.

19. The optical device of claim 18, further comprising a first bridge die embedded within the third metallization layer.

20. The optical device of claim 15, further comprising a first semiconductor device and a second semiconductor device bonded to the first metallization layer, the first semiconductor device connected to the second semiconductor device through the first optical package.
